(19) United States
(12) Patent Application Publication
(10) Pub. No.: US 2011/0307936 A1
(43) Pub. Date: Dec. 15, 2011

(54) NETWORK ANALYSIS

(75) Inventors: Markus Braendle, Niederrohrdorf (CH); Ragnar Schierholz, Wurenlos (CH); Hadeli Hadeli, Baden (CH); Cristian Tuduce, Gattikon (CH)

(73) Assignee: ABB RESEARCH LTD., Zurich (CH)

(21) Appl. No.: 13/158,031

(22) Filed: Jun. 10, 2011

Related U.S. Application Data
(63) Continuation of application No. PCT/EP2009/065486, filed on Nov. 19, 2009.

(30) Foreign Application Priority Data
Dec. 17, 2008 (EP) 08171902.3

(51) Int. Cl. G06F 21/00; G06F 15/16

(52) U.S. Cl. 726/1; 709/224

(57) ABSTRACT

A method and system are provided for analyzing a network. The method and system convert network specification information into a single intermediate representation of the network. The intermediate representation can then be used to determine security parameters as well as expected data traffic parameters.

### RELATED APPLICATION

This application claims priority as a continuation application under 35 U.S.C. §120 to PCT/EP 2009/065486, which was filed as an International Application on Nov. 19, 2009 designating the U.S., and which claims priority to European Application 08171902.3 filed in Europe on Dec. 17, 2008. The entire contents of these applications are hereby incorporated by reference in their entireties.

### FIELD

The present disclosure relates to a method and system for analyzing a network, such as in configuring network security, for example.

### BACKGROUND INFORMATION

More and more standards and regulations require critical infrastructure systems and networks to be protected against electronic attacks. These requirements add to the workload of commissioning engineers and/or operators. Setting up security measures to protect control systems is not a trivial task. In the control system environment, operators or commissioning engineers are rarely security experts and often not well-trained to deal with the cyber security of control systems.

Security measures commonly used in environments like office networks are geared towards fairly dynamic systems. The legitimate communications are difficult to predict, because of the dynamics in the use of the network. On the contrary, in an industrial environment, the legitimate traffic is predictable. However, conventional methods and tools for configuring network security measures and for continuously monitoring network security do not appropriately leverage these deterministic characteristics of industrial environments.

Various types of security measures can be found in a typical IT environment such as an office network. For example, firewalls are used to separate a network from external networks and to split it up into several sub-networks. Firewalls are configured by rules which describe which network traffic shall be allowed to pass the network perimeters and which network traffic is supposed to be blocked. State-of-the-art firewalls use traffic characteristics such as the source address, the destination address, the service used (e.g. web traffic vs. e-mail traffic), the state of the session (with regard to the protocol used, e.g. TCP) and/or deep inspection of network packets (with regard to the protocol used, e.g. HTTP or SMTP).

While firewalls protect networks and sub-networks at their perimeter, there are also security measures which are applied within the network to be protected. For example, intrusion detection systems (IDS) are used to identify intrusions (e.g. by hackers, viruses or worms). However, conventional available IDSs have shortcomings. There are generally two approaches to IDSs. One uses signatures for known attacks to detect them when they happen in the monitored network. However, this approach can only detect attacks which are known and for which a signature has been created. If the attack is new or a sufficiently modified version of a known attack, the signatures will not match and the attack cannot be detected. Furthermore, any traffic that is not seen on the network cannot be matched against a signature, and as a result, missing traffic is not detected by available signature-based IDS. The second approach uses a learning phase to build a statistical model from assumed normal system behavior and later on detects any deviation from the statistical model. However, this approach largely depends on the system capturing every communication that may be considered normal in the network during the learning phase. For systems which contain events that happen rarely (e.g. emergency modes in control systems) this can be difficult to ensure. Thus, both approaches have the drawback that they either produce too many alarms when no attack is present (e.g. false positive), or they produce too few alarms when attacks are happening (e.g. false negative). Particularly, they do not leverage the deterministic characteristics of a control system.

Further security measures include access control, which determines which actors (e.g. users or system components) shall be allowed which level of access to different resources in the network or system, or detailed logging, which collects information about relevant events as they happen in the network or system.

Intrusion detection uses signatures to differentiate between normal traffic and malicious or otherwise undesired traffic, so that unexpected data traffic can be detected. The configuration data provides signatures describing known weaknesses in, and attack patterns against, the protocols and services that are used in the network modeled by the intermediate representation. Furthermore, the configuration data provides signatures for those known kinds of traffic which are not desired at all in the network (e.g. e-mail traffic may not be desired in a control system and thus a signature detecting any e-mail traffic could be generated). If any traffic is seen that matches any of the defined patterns/signatures, an alarm is raised.

In general, no methods or tools exist currently that take available system design information from control systems and automatically transform it into configuration data for security measures of any type (firewall, IDS, access control or other). In addition, there is also no method or tool that takes available system design information from control systems and transform it into a model of the communication, or configuration data to detect any missing expected traffic in the system. For the latter case, even the Commercial-Off-The Shelf software on intrusion detection and/or anomaly detection can only detect/scan actual traffic for any malicious item if a signature/model on such malicious/anomaly traffic is made available. Even if signatures/models are available, there is no determinism whether the signatures/models cover all possible malicious traffic or other anomalies.

### SUMMARY

An exemplary embodiment of the present disclosure provides a method of analyzing a network. The exemplary method includes receiving description data which includes specification information concerning a specification of a network. The exemplary method also includes automatically determining, in a parser, model data by extracting explicit and implicit data from the description data, where the explicit data is explicitly contained in the description data, and the implicit data is derived from the explicit data and predetermined rules and conditions. In addition, the exemplary method includes building a representation of the network using such model data.

An exemplary embodiment of the present disclosure includes a method of analyzing a network. The exemplary method includes receiving description data which includes specification information concerning a specification of a network, and automatically determining, in a configuration generator, a plurality of security parameters from a representation of the network based on the received description data. In addition, the exemplary method includes configuring, in the configuration generator, security measures using the determined security parameters. The automatically determining of the plurality of security parameters includes automatically determining model data by extracting explicit and implicit data from the description data, where the explicit data is explicitly contained in the description data and the implicit data is derived from the explicit data and predetermined rules and conditions, and building a representation of the network using the determined model data.

An exemplary embodiment of the present disclosure provides a system for analyzing a network. The exemplary system includes a parser connected to receive description data which includes specification information concerning a specification of a network. The parser is configured for automatically determining model data by extracting explicit and implicit data from the received description data, where the explicit data is explicitly contained in the description data, and the implicit data is derived from the explicit data and predetermined rules and conditions. The parser is also configured for building representation data of the network using the determined model data.

An exemplary embodiment of the present disclosure provides a system for analyzing a network. The exemplary system includes a security unit configured for receiving security parameters and configuring at least one security measure using the received security parameters. The exemplary system also includes a configuration generator connected to receive representation data. The configuration generator is configured for generating the security parameters and automatically determining a plurality of security parameters from the received representation data for transmission to the security unit. The exemplary system also includes a parser connected to receive description data which includes specification information concerning a specification of a network. The parser is configured for generating the representation data and automatically determining model data by extracting explicit and implicit data from received description data, where the explicit data is explicitly contained in the description data, and the implicit data is derived from the explicit data and predetermined rules and conditions. In addition, the parser is configured for building representation data of the network using the determined model data.

### BRIEF DESCRIPTION OF THE DRAWINGS

Additional refinements, advantages and features of the present disclosure are described in more detail below with reference to exemplary embodiments illustrated in the drawings, in which:

FIG. 1 is a block diagram illustrating an overall concept of a system according to an exemplary embodiment of the present disclosure;

FIG. 2 is a block diagram illustrating one possible implementation of the concept of FIG. 1;

FIG. 3 is a flow diagram illustrating steps in a method according to an exemplary embodiment of the present disclosure;

FIG. 4 is a block diagram illustrating elements in an implementation of an exemplary embodiment of the present disclosure;

FIG. 5 is an example of an extract SCL file; and

FIG. 6 is an example of an extract of an ABB (R) System 800xA System Planner file.

### DETAILED DESCRIPTION

Exemplary embodiments of the present disclosure are directed to a method and system which provide:

(1) automated generation of a model of the expected communication in a control system network based on available system information;
(2) automated generation of configuration data for various network security measures based on a generated model; and
(3) a method/tool to monitor and alert on the absence of expected traffic based on the generated model.

An exemplary embodiment of the present disclosure provides a method of analyzing a network. The exemplary method includes receiving description data which includes specification information concerning a specification of a network. The exemplary method also includes automatically determining model data by extracting explicit and implicit data from the description data, where the explicit data is explicitly contained in the description data, and the implicit data is derived from the explicit data and predetermined rules and conditions. In addition, the exemplary method includes building a representation of the network using such model data.

The exemplary method can also include automatically determining a plurality of security parameters from the representation of the network, and configuring security measures using such security parameters.

An exemplary embodiment of the present disclosure provides a method of analyzing a network. The exemplary network includes automatically determining a plurality of security parameters from a representation of the network, and configuring security measures using such security parameters. The representation results from receiving description data which includes specification information concerning a specification of a network. The exemplary method also includes automatically determining model data by extracting explicit and implicit data from the description data, where the explicit data is explicitly contained in the description data, and the implicit data is derived from the explicit data and predetermined rules and conditions. In addition, the exemplary method includes building a representation of the network using such model data.

In such methods, the security parameters may include parameters for a firewall, and the method may include generating configuration data for such a firewall to prevent unauthorized access in dependence upon such parameters.

In such methods, the security parameters may include parameters for intrusion detection, and the method may include configuring an intrusion detection unit in dependence upon such parameters.

In such methods, the security parameters may include parameters for expected data traffic, and the method may include automatically monitoring data traffic, and signaling a lack of expected data traffic in dependence upon such parameters.

The model data may include information concerning at least one of expected data traffic, inter-node communication patterns, and device security information. The description data may represent design information for the network. The specification information may include information regarding at least one of network node information, node interconnection information, installed software information, and device configuration information.

An exemplary embodiment of the present disclosure provides a system for analyzing a network. The system includes a parser which is connected to receive description data which includes specification information concerning a specification of a network. The parser is configured for automatically determining model data by extracting explicit and implicit data from received description data, where the explicit data is explicitly contained in the description data, and the implicit data is derived from the explicit data and predetermined rules and conditions. In addition, the parser is configured for building representation data of such a network using such model data.

The exemplary system may also include a configuration generator connected to receive representation data from the parser, and configured for automatically determining a plurality of security parameters from such received representation data for transmission to a security unit.

The exemplary system may further include a security unit connected to receive security parameters from the configuration generator, and configured for executing at least one security measure using such received security parameters.

An exemplary embodiment provides a system for securing a network. The exemplary system includes a security unit connected to receive security parameters. The security unit configures at least one security measure using such received security parameters. The exemplary system includes a configuration generator configured for generating the security parameters. The configuration generator is connected to receive representation data, and is configured for automatically determining a plurality of security parameters from such received representation data for transmission to the security unit. The exemplary system also includes a parser configured for generating the representation data. The parser is connected to receive description data which includes specification information concerning a specification of a network. The parser is configured for automatically determining model data by extracting explicit and implicit data from received description data, where the explicit data is explicitly contained in the description data, and the implicit data is derived from the explicit data and predetermined rules and conditions. The parser is also configured for building representation data of such a network using such model data.

The security parameters may include parameters for a firewall, and the security unit may then be configured for executing a firewall to prevent unauthorized network access in dependence upon such parameters.

The security parameters may include parameters for expected data traffic, and the security unit may then be configured for automatically monitoring network data traffic, and signaling a lack of expected data traffic in dependence upon such parameters.

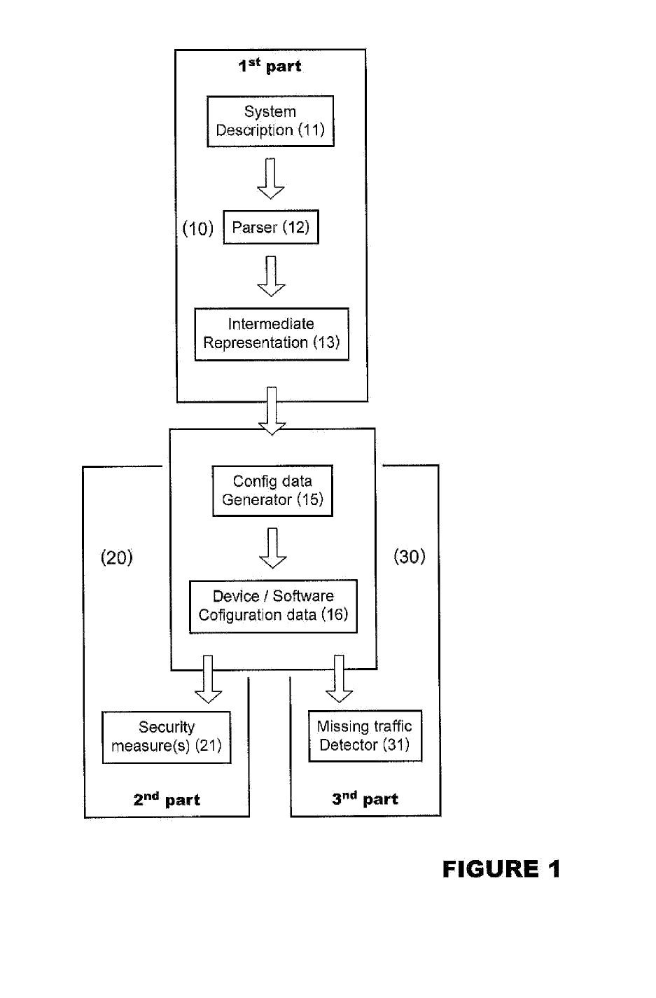

FIG. 1 is a block diagram illustrating an overall concept of a system according to an exemplary embodiment of the present disclosure. The concept is divided into three parts. A first part 10 serves to convert system description data 11 into an intermediate representation 13 using a parser 12. The parser 12 extracts from the system description data 11 explicit information relevant to the network setup and its security. In addition, the parser derives information that is implicitly stored in the system description data 11. The implicit information is derived by interpreting the explicitly stated information using predetermined rules and conditions. For example, the semantics of the system description language can be interpreted to derive additional information required to configure security settings. This information is stored in the intermediate representation 13. A configuration data generator 15 translates the intermediate representation into configuration data 16 for networking devices/software. This configuration data is supplied to the networking devices/software, and may be stored, or may be transient in nature. A second part 20 of the concept makes use of the configuration data 16 to develop security measures 21 specifically for the network. A third part 30 of the concept uses the configuration data to produce configuration data for a missing traffic detector 31 to detect when expected data traffic is missing in the network. It will be appreciated that the third part 30 is really a subset of the second part 20, since the missing traffic detector can be considered as a security measure for the network

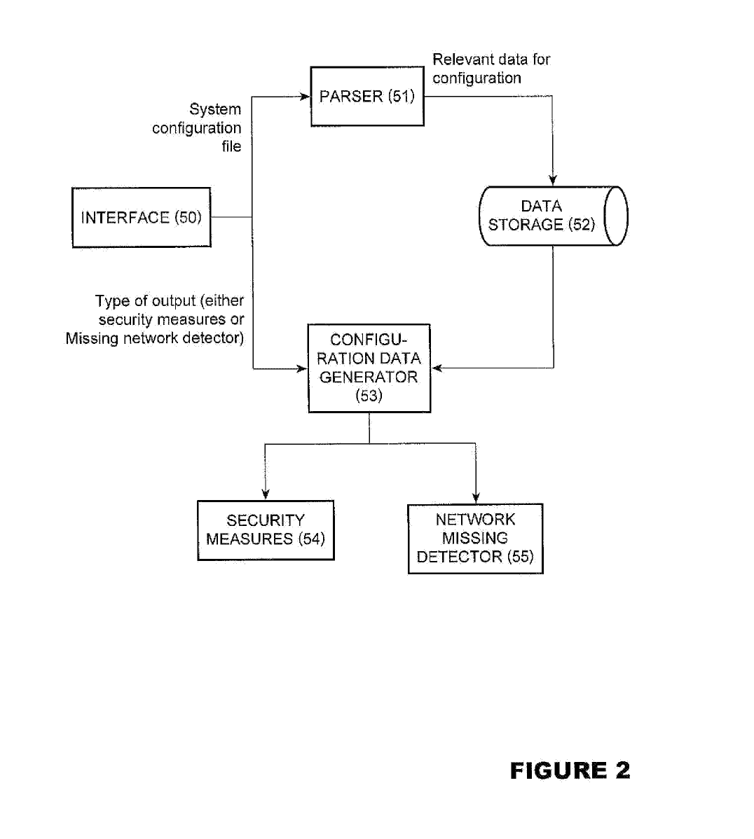

FIG. 2 is a block diagram illustrating one possible implementation of the concept of the present disclosure, according to an exemplary embodiment. The FIG. 2 implementation includes several functional blocks. An input interface 50 is provided for receiving input data, and supplies system description data to a parser 51 for generating an intermediate representation from that system description data. The parser 51 supplies data to a data storage device 52 which stores the intermediate representation information. It is to be appreciated that the data storage device 52 may be provided by a persistent storage device such as a hard disk drive, solid state disk drive, or flash memory drive, or may be provided by non-persistent storage, for example, a random access memory (RAM) or other memory device.

A configuration data generator 53 retrieves the stored intermediate representation information, generates appropriate configuration data and then supplies the configuration data to a security unit 54, or a missing traffic detector 55. The security unit 54 provides any selected security measures in dependence upon the configuration information received from the configuration data generator 53. The missing traffic detector 55 is a specific type of security measure, and monitors the network data traffic for missing expected traffic, in accordance with information contained in the received configuration data. It will be readily appreciated that the security measures provided by the security unit 54 can be any appropriate security measure, and that the configuration data generator 53 is operable to produce any suitable configuration data.

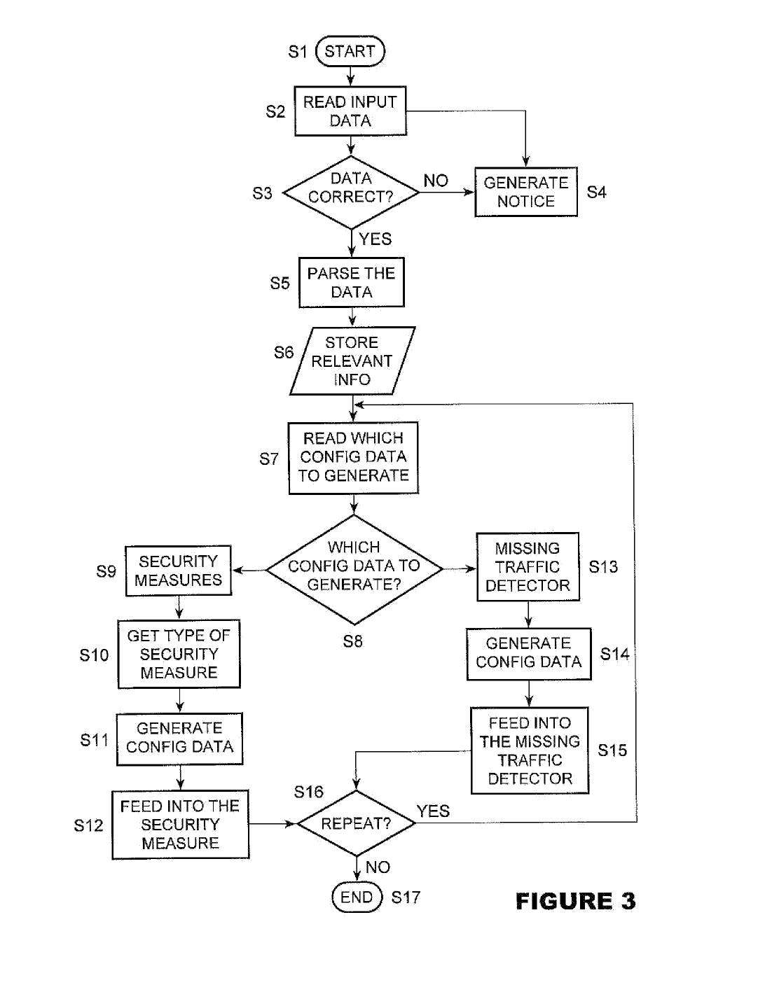

FIG. 3 is a flow diagram illustrating steps in a method according to an exemplary embodiment of the present disclosure. Reference will also be made to FIGS. 1 and 2. The process begins at step s1, and an input system description data 11 is read (step S2) by the parser 51, which determines whether the data 11 is of the correct type and format (step S3). If the data is incorrect in any way, an appropriate notice is generated (step S4) and presented to an appropriate interface. If the data is correct, then it is automatically converted (step S5) to an intermediate representation 13 by the parser 51. The intermediate representation 13 is then stored (step S6) in the data storage device 52. The intermediate representation 13 provides a model of the network. For instance, the intermediate representation includes information that models available nodes in the network, communication patterns between those nodes, security of the underlying networking and communication patterns, and is based on the information stored explicitly and implicitly in the system description data. As described above, useful security information is derived from implicitly held information in the system description data by analysis of that information, its interrelationships, and the semantics of the system description language. It is determined (step S7) which configuration data is to be generated automatically. Alternatively, all possible configurations, or a predefined set of configurations, could be generated by the system. If security measures data is to be generated, then the process moves to step S9. The type of security measure to be determined is retrieved (step S10), and the appropriate configuration data is generated (step S11) by the configuration data generator 53. The security measures configuration data is then supplied (step S12) to the security unit 54.

The security measures may include defining rules for a firewall, detecting unexpected data traffic on the network, and other suitable measures. A firewall is a device which permits or blocks data traffic based on source (sender), destination (receiver), service used and/or state of the session between source and destination. The configuration data provided by the configuration data generator is a detailed list of all allowed network connections between various nodes in the target network, specifying source, destination and service for each allowed connection. The configured firewall then has a complete list of allowed connections and can block anything else.

Other examples of a security measure include an access control system which controls access to resources on the network and which can alert if a user tries to use a resource in an unauthorized manner.

The security unit 54 implements the security measures and then causes an alarm condition if a breach is determined.

If missing traffic detector configuration data is to be generated, then the process moves from step S8 to step S13, and the appropriate configuration data is generated (step S14), and then supplied (step S15) to the missing traffic detector 55.

The missing traffic detector 55 watches for desired data traffic. If such desired data traffic is not detected, then a security breach is inferred, and an alarm is raised. The configuration data provides a model of expected traffic describing the characteristics of the traffic, e.g. source, destination, service used and frequency of expected occurrence. The missing traffic detector 55 then operates to detect the absence of such expected traffic and on such absence, raises an alert.

The generation of configuration data can be repeated as required, as determined by step S16. If no further configuration data are required, then the process is ended (step S17).

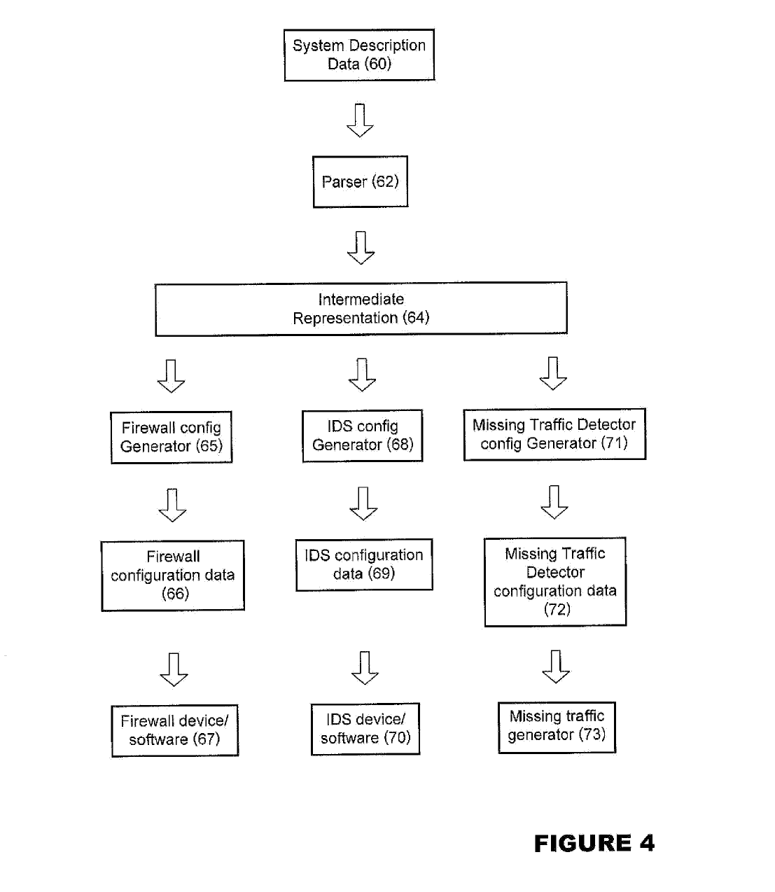

Different embodiments of this concept can implement different parsers and/or different configuration data generators. Two examples are described below, both with reference to FIG. 4. The first example translates system description data, for example IEC 61850 SCL files, into configuration data, and the second translates ABB(R) System 800xA System Planner files into configuration data. The SCL files and the System Planner files are referred to as system description data for the sake of clarity.

The first example describes the automatic translation of SCL system description data into intrusion detection system (IDS) configuration, firewall configuration files and missing traffic detector configuration data. The system description data 60 describes the components and the configuration parameters of all devices in a network. A parser 62 extracts explicit information that is security-relevant, and stores that information as an intermediate representation 64. In addition, the system description data 60 is analyzed to extract implicit security relevant information from the explicit data and a set of predetermined rules and conditions, such as the semantics of the description language.

For example, the system description file 60 data may define entities such as intelligent electronic devices (IEDs), including the network address of the IED. Within such entities, the data may define GOOSE message blocks (GSE), for example. If such a GOOSE message block is found, the parser 62 generates a model element defining GOOSE traffic from the IED's network address as expected traffic. Furthermore, traffic using the protocols MMS and ICMP is, by default, legitimate traffic, even though not explicitly specified in an SCL file. In order to generate this implicit information, the parser 62 refers to stored rules and information concerning the system description language and data.

The intermediate representation 64 can be further processed or optimized (e.g., ordering of the intermediate representation to generate firewall rules more easily).

Based on the intermediate representation 64:

1. A firewall configuration data generator 65 generates configuration data (rules) 66 for a firewall. In one example, the firewall can be used to detect and block any unintended (unexpected) traffic. From the intermediate representation 64, details of communications which are allowed or disallowed are extracted.

2. An IDS configuration data generator 68 generates configuration data 69 for an intrusion detection system (IDS) 70. In this case, based on the input data, the IDS can be configured to alert on data traffic or malicious data traffic that should not be allowed in the system(s).

3. A missing traffic detector generator 71 generates configuration data 72 for a missing traffic detector 73, for example, to detect missing GOOSE traffic, as described in more detail below.

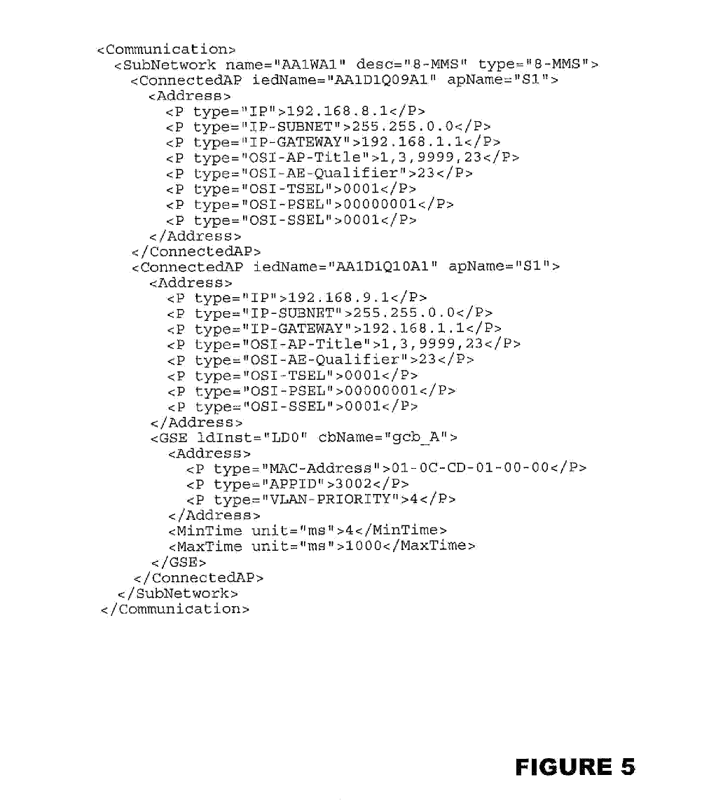

A particular example of processing an extract from an SCL file will now be described. It is to be appreciated that this file merely represents one possible example, and should not be construed as limiting in any way. The example extract SCL file is shown in FIG. 5, and several characteristics are automatically determined:

1. There are two IEDs in the system (see the ConnectedAP block), i.e. AA1D1Q09A1 and AA1D1Q10A1

2. Only AA1D1Q10A1 can send out GOOSE message (see the GSE block)

3. ICMP and MMS are, by default, allowed

Having this example, the SCL parser 62 extracts the necessary information, such that the following configuration can be generated:

1. The firewall configuration data generator 65 generates, in this example, firewall rules 66 that allow only traffic that comes and goes to the listed IP addresses, in this case 192.168.8.1 and 192.168.9.1.

2. The IDS configuration data generator, for this example:

generates a signature that detects malicious MMS traffic, for example, traffic exploiting known weaknesses in the protocol version used or known weaknesses in product versions used, and

detects if there is any GOOSE message apart from the one from AA1D1Q10A1

3. The missing traffic detector generator 71 generates configuration data 72 to enable the missing traffic generator 73 to detect any missing GOOSE traffic from AA1D1009A1.

A second example describes the translation of ABB(R) System 800xA System Planner files into intrusion detection system (IDS) configuration and firewall configuration data. The System Planner files contain a description of a system installation. Based on these files, the installer installs and configures all the software components of the system. The parser 62 extracts explicit information that is security-relevant, and stores the extracted explicit information as an intermediate representation 64. In addition, the system description data 60 is analyzed to extract implicit security relevant information from the explicit data and the semantics of the description language. The implicit information is also stored in the intermediate representation 64, in a similar manner to the previous example. The system then operates as follows:

1. The firewall configuration data generator 65 generates rules 66 to block disallowed traffic and allow allowed traffic. For instance, an exemplary ABB(R) System 800xA includes several elements, each of which provides some services. Each service allows only communication via one or several determined protocol(s) and port(s). Hence, unused ports are not used for communication and thus need to be blocked.

2. The IDS configuration data generator 68 generates the configuration data 69 for an IDS 70. For instance, the generator 68 can create configuration data to guard the data bus traffic, for example, an industry standard MODBUS.

3. The missing traffic detector generator 71 generates configuration data 72 for the missing traffic detector 73, for instance, data for history log server that tracks and stores system changes, predefined data points and the like.

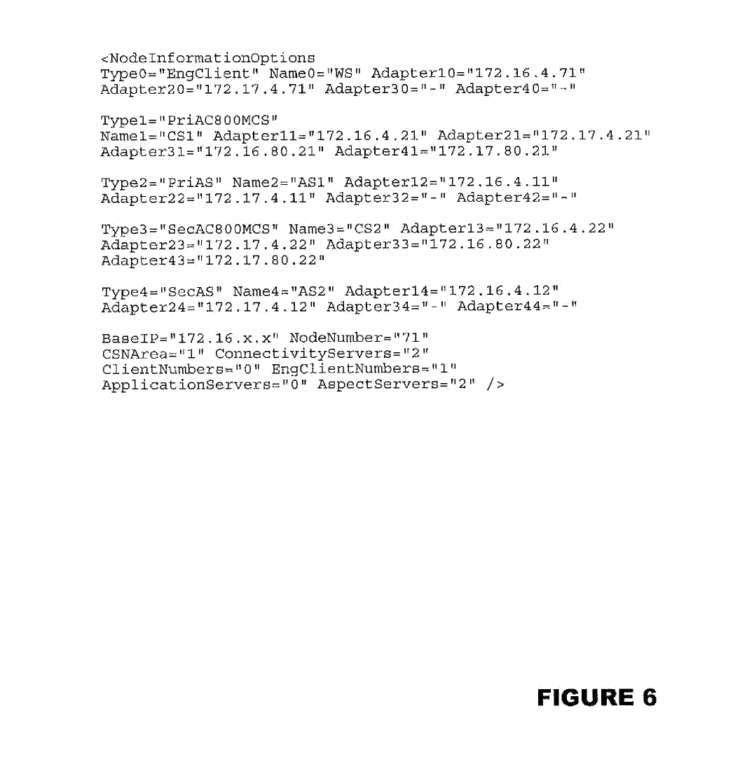

An example extract of an ABB(R) System 800xA System Planner file is shown in FIG. 6. Once again, this file extract is described merely by way of example only, and should not be considered as limiting the scope of the disclosure.

In the given ABB(R) System 800xA System Planner file, it is possible to identify the following characteristics:

1. There are five nodes: EngClient, PriAC800MCS, PriAS, SecAC800MCS, and SecAS;

2. Each node has at least two IP addresses; and

3. Traffic for redundancy network routing protocol is available by default.

After receiving this example System Planner file, the parser 62 extracts necessary information, such that the following configuration can take place:

1. The firewall configuration data generator 65 can, for instance, generate firewall rules 66 that block unnecessary ports at every node. For instance, nodes PriAS and SecAS receive communication via port 80. Then, firewall rules 66 are generated to block every port except port 80.

2. The IDS configuration data generator 68, for this example, can:

generate a signature that detects malicious MODBUS traffic, for example, traffic exploiting known weaknesses in the protocol version used or known weaknesses in product versions used; and

generate a signature that detects undesired port 80 traffic to nodes other than PriAS and SecAS.

3. The missing traffic detector generator 71 generates configuration data 72 to detect missing history traffic, such as log files.

Exemplary embodiments of the present disclosure were described above with respect to functional features respectively performed by the various constituent elements of the system. It is to be understood that the various elements illustrated in the drawings can be embodied as components of one or more computing devices (e.g., a CPU). For example, a respective processor of one or more computing devices can be configured to execute a computer program recorded on a non-transitory computer-readable recording medium (e.g., the persistent or non-persistent storage devices as described above) for carrying out the respective functions of the various elements of the exemplary system. Alternatively, the various elements illustrated in the drawings can be implemented by discrete hardware components configured to carry out the features of the respective elements. For instance, the interface 50, parser 51, configuration data generator 53, security unit 54 and/or network missing detector 55 as illustrated in FIG. 2, as well as the parser 62, firewall configuration generator 65, firewall device 67, IDS configuration generator 68, IDS device 70, missing traffic detector configuration generator 71, and/or missing traffic generator 73 as illustrated in FIG. 4, can be implemented by one or more discrete hardware components, such as a processor of a computing device, for example, which executes a program for carrying out the respective functions, where such a program is stored in a non-transitory computer-readable recording medium communicatively connected to or contained in one or more devices.

Furthermore, it is to be understood that the various elements of the exemplary method described with respect to FIG. 3 are performed by the structural components as described above.

It will be appreciated from the description given above, that embodiments of the present disclosure are able to provide systems and techniques that automatically determine a network configuration from system description data and that can use the configuration information to determine security settings and missing traffic settings.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method of analyzing a network, comprising the steps of:
receiving description data which includes specification information concerning a specification of a network;
automatically determining, in a parser, model data by extracting explicit and implicit data from the description data, the explicit data being explicitly contained in the description data, and the implicit data being derived from the explicit data and predetermined rules and conditions; and
building a representation of the network using such model data.

2. A method as claimed in claim 1, further comprising
automatically determining a plurality of security parameters from the representation of the network; and
configuring security measures using the determined security parameters.

3. A method of analyzing a network, comprising the steps of:
receiving description data which includes specification information concerning a specification of a network;
automatically determining, in a configuration generator, a plurality of security parameters from a representation of the network based on the received description data; and
configuring, in the configuration generator, security measures using the determined security parameters,
wherein the automatically determining of the plurality of security parameters includes automatically determining model data by extracting explicit and implicit data from the description data, the explicit data being explicitly contained in the description data and the implicit data being derived from the explicit data and predetermined rules and conditions, and building a representation of the network using the determined model data.

4. A method as claimed in claim 2, wherein the security parameters include parameters for a firewall, and
wherein the method comprises configuring a firewall to prevent unauthorized access in dependence upon the security parameters.

5. A method as claimed in claim 2, wherein the security parameters include parameters for intrusion detection, and
wherein the method comprises configuring an intrusion detection unit in dependence upon the security parameters.

6. A method as claimed in claim 2, wherein the security parameters include parameters for expected data traffic, and
wherein the method comprises automatically monitoring data traffic, and signaling a lack of expected data traffic in dependence upon the security parameters.

7. A method as claimed in claim 1, wherein the model data include information concerning at least one of expected data traffic, inter-node communication patterns, and device security information.

8. A method as claimed in claim 1, wherein the description data represent design information for the network.

9. A method as claimed in claim 1, wherein the specification information includes information regarding at least one of network node information, node interconnection information, installed software information, and device configuration information.

10. A system for analyzing a network, comprising:
a parser connected to receive description data which includes specification information concerning a specification of a network,
wherein the parser is configured for automatically determining model data by extracting explicit and implicit data from the received description data, the explicit data being explicitly contained in the description data, and the implicit data being derived from the explicit data and predetermined rules and conditions, and the parser being configured for building representation data of the network using the determined model data.

11. A system as claimed in claim 10, further comprising:
a configuration generator connected for receiving representation data from the parser, and automatically determining a plurality of security parameters from the received representation data for transmission to a security unit.

12. A system as claimed in claim 11, further comprising a security unit connected to receive security parameters from the configuration generator, and configured for executing at least one security measure using the received security parameters.

13. A system for analyzing a network, comprising:
a security unit configured for receiving security parameters and configuring at least one security measure using the received security parameters;
a configuration generator connected to receive representation data, the configuration generator being configured for generating the security parameters and automatically determining a plurality of security parameters from the received representation data for transmission to the security unit; and
a parser connected to receive description data which includes specification information concerning a specification of a network, the parser being configured for generating the representation data and automatically determining model data by extracting explicit and implicit data from received description data, the explicit data being explicitly contained in the description data, and the implicit data being derived from the explicit data and predetermined rules and conditions, and the parser being configured for building representation data of the network using the determined model data.

14. A system as claimed in claim 10, wherein the security parameters include parameters for a firewall, and the security unit is configured for executing a firewall to prevent unauthorized network access in dependence upon the security parameters.

15. A system as claimed in claim 10, wherein the security parameters include parameters for expected data traffic, and the security unit configured for automatically monitoring network data traffic, and signaling a lack of expected data traffic in dependence upon such parameters.

16. A method as claimed in claim 4, wherein the security parameters include parameters for intrusion detection, and
wherein the method comprises configuring an intrusion detection unit in dependence upon the security parameters.

17. A method as claimed in claim 16, wherein the security parameters include parameters for expected data traffic, and
wherein the method comprises automatically monitoring data traffic, and signaling a lack of expected data traffic in dependence upon the security parameters.

18. A method as claimed in claim 17, wherein the model data include information concerning at least one of expected data traffic, inter-node communication patterns, and device security information.

19. A method as claimed in claim 17, wherein the description data represent design information for the network.

20. A method as claimed in claim 17, wherein the specification information includes information regarding at least one of network node information, node interconnection information, installed software information, and device configuration information.

21. The method as claimed in claim 3, wherein the automatically determining of the model data, and the building of the representation of the network is performed in a parser.

22. A method as claimed in claim 3, wherein the security parameters include parameters for a firewall, and
wherein the method comprises configuring a firewall to prevent unauthorized access in dependence upon the security parameters.

23. A method as claimed in claim 22, wherein the security parameters include parameters for intrusion detection, and
wherein the method comprises configuring an intrusion detection unit in dependence upon the security parameters.

24. A method as claimed in claim 23, wherein the security parameters include parameters for expected data traffic, and
wherein the method comprises automatically monitoring data traffic, and signaling a lack of expected data traffic in dependence upon the security parameters.

25. A method as claimed in claim 3, wherein the security parameters include parameters for intrusion detection, and
wherein the method comprises configuring an intrusion detection unit in dependence upon the security parameters.

26. A method as claimed in claim 3, wherein the security parameters include parameters for expected data traffic, and
wherein the method comprises automatically monitoring data traffic, and signaling a lack of expected data traffic in dependence upon the security parameters.

27. A method as claimed in claim 3, wherein the model data include information concerning at least one of expected data traffic, inter-node communication patterns, and device security information.

28. A method as claimed in claim 3, wherein the description data represent design information for the network.

29. A method as claimed in claim 3, wherein the specification information includes information regarding at least one of network node information, node interconnection information, installed software information, and device configuration information.

30. A system as claimed in claim 12, wherein the security parameters include parameters for a firewall, and the security unit is configured for executing a firewall to prevent unauthorized network access in dependence upon the security parameters.

31. A system as claimed in claim 30, wherein the security parameters include parameters for expected data traffic, and the security unit configured for automatically monitoring network data traffic, and signaling a lack of expected data traffic in dependence upon such parameters.

32. A system as claimed in claim 13, wherein the security parameters include parameters for a firewall, and the security unit is configured for executing a firewall to prevent unauthorized network access in dependence upon the security parameters.

33. A system as claimed in claim 32, wherein the security parameters include parameters for expected data traffic, and the security unit configured for automatically monitoring network data traffic, and signaling a lack of expected data traffic in dependence upon such parameters.

34. A system as claimed in claim 13, wherein the security parameters include parameters for expected data traffic, and the security unit configured for automatically monitoring network data traffic, and signaling a lack of expected data traffic in dependence upon such parameters.
